(19) United States
(12) Patent Application Publication
(10) Pub. No.: US 2003/0055665 A1
(43) Pub. Date: Mar. 20, 2003

(54) Mobile emissions data collection, aggregation, and trading

(75) Inventor: Scott D. Fleming, Calgary (CA)

Correspondence Address: BENNETT JONES LLP, 4500 Bankers Hall East, 855 - 2nd Street SW, Calgary, AB, T2P 4K7, CA

(73) Assignee: TELETRIPS INC.

(21) Appl. No.: 10/128,648

(22) Filed: Apr. 23, 2002

Related U.S. Application Data
(60) Provisional application No. 60/330,283, filed on Oct. 18, 2001.

(30) Foreign Application Priority Data
Aug. 22, 2001 (DE) 201 13 853.0

(51) Int. Cl. G06F 17/60

(52) U.S. Cl. 705/1; 705/412

(57) ABSTRACT

A system and method for tracking pollution credits earned by an employer through the application of a telework program, including registering an employee of the employer, receiving communications from the employee of data respecting telework performed by the employee, calculating pollution credits earned by the employer as a result of the telework performed by the employee, and communicating the pollution credits earned by the employer to a third party server.

This application claims priority from U.S. Provisional Patent Application No. 60/330,283, filed Oct. 18, 2001, and entitled “Teletrips”, from which priority is claimed and which is incorporated herein by reference.

### FIELD

This invention relates generally to the field of trading of environmental pollution credits and in particular to a method for collecting data from teleworkers and calculating pollution credits resulting from reduced commuting by teleworkers.

### BACKGROUND

One of the most pressing environmental problems in major metropolitan areas is ever-increasing traffic congestion and its resultant air pollution. In particular, ground level ozone caused by NOₓ, volatile organic compounds (VOCs), and other ozone precursors, has proven resistant to the technological controls that have reduced other emissions. One clear way to reduce ground level ozone is to reduce vehicle usage during key periods of the day. By reducing the vehicle miles traveled (VMTs) by daily commuters, fewer ozone precursors will be emitted and less ground level ozone will be formed, improving the air quality in urban areas. A promising way to reduce VMTs is teleworking, a process where an employee will work from home or from a designated telecommuting center instead of commuting into a central office.

Several types of costs are involved in driving including: direct user costs; public infrastructure costs; private parking costs; congestion costs; external accident costs; and pollution costs. All of these costs may be reduced through telework, often in synergistic ways never envisioned by employees, employers, or communities.

Some of the benefits of telework are as follows.

Employee Telework Benefits

Collectively, telework often represents an “indirect pay raise” which applies equally and more meaningfully to those in lower income brackets. Benefits include:

Higher individual productivity due to more hours worked per day, more work completed in a hour, and less time missed from work.

Greater job satisfaction and sense of accomplishment.

Less stress and better health.

Reduced auto insurance—“Low Mileage Vehicle” rates are offered to teleworkers.

Better opportunity for advancement—teleworkers receive promotions more often than their office bound co-workers due to their increased productivity, higher quality of work, increased loyalty, and increased morale.

Improved balance between family and work responsibilities.

Employer Telework Benefits

Compared with the “Traditional Office—Industrial Age Model”, full time telework frequently translates into four workers accomplishing the same work previously done by five employees, without the four working any longer. Benefits include:

Improved recruiting and retention: Eighty seven percent of job applicants would take a job that offers telecommuting over a job that does not.

Greater company loyalty and enthusiasm.

Reduced illness and quicker recoveries.

Increased productivity

Reduced real estate costs

Greater opportunity to acquire new skills and qualify for promotion.

Eased facility moves and avoidance of employee relocation.

Improved work quality through faster processing, fewer errors, and shorter response time for communications.

Fewer days absent

Community Telework Benefits

The only near-term (within the next decade) relief from congestion and the adverse effects of vehicle emissions is to be found in employer supported full-time telework programs:

Cleaner air (reduced nitrous oxides, particulate matter, carbon dioxide)

Less peak-hour congestion:

on telecommuting days, telecommuters make virtually no commute trips;

reduced peak-period trips;

reduced total distance traveled; and

reduced freeway miles.

(Non-work trips continued to be made during lunch, late afternoon and evenings)

Fewer auto/commuting accidents and 911 calls.

Lower expenditures for new highway and rail programs.

More funds available to improve safety of existing infrastructure.

Reduced crime rates as homes are occupied during the workday.

Better balance of economic activity between rural and urban areas.

The U.S. Clean Air Act Amendments of 1990 (“CAAA”) gave legislative recognition to a new form of environmental regulation, clean air markets. The Acid Deposition Control Program (Title IV of CAAA) represents the flagship market system. In this system, sources must reduce sulfur dioxide (SO₂) emissions in two phases. Each regulated source is allotted SO₂ allowances based on actual emissions levels in tons and required reductions. These SO₂ allowances are “marketable” in that sources may trade with one another as a compliance strategy. The SO₂ market is derived from sources that are motivated to over-control emissions and sell unused allowances and sources that prefer to under-control emissions and be buyers. Differential control costs among the many regulated sources generally determines who opts for being a seller or a buyer of SO₂ allowances.

Title I of the CAAA also authorizes the use of market-based approaches for attainment of national ambient air quality standards. In particular, certain non-attainment areas for ozone, carbon monoxide, sulfur oxides and nitrogen dioxide are identified as candidates for these approaches (called “economic incentive programs under CAAA). Under the CAAA, a state may elect to implement a market system as part of the implementation plan that must be submitted. For instance, a state may choose to allow emissions trading for volatile organic compounds (VOCs) among designated stationary sources to help reduce compliance costs and meet emissions targets for ozone attainment.

The invention provides the link between initiatives to promote telework and track the accumulation of Telecommuting Emissions Reductions Credit (“TERC”) by participating corporations.

Two basic types of emissions market systems can be utilized to help achieve clean air requirements for stationary sources:

Rate-based (no emission caps)

Emissions budget (cap and trade like SO₂ allowances)

These systems are designed to operate within formally designated non-attainment areas where the state has determined that certain amounts of emissions reductions must be achieved.

### SUMMARY

In one aspect of the invention a method of tracking pollution credits earned by a corporate through the application of a telework program is provided that includes registering an employee of the corporation, receiving communications from the employee of data respecting telework performed by the employee, calculating pollution credits earned by the corporation as a result of the telework performed by the employee, and communicating the pollution credits earned by the corporation to a third party server.

### BRIEF DESCRIPTION OF DRAWINGS

FIG. 1 is a flowchart illustrating the mobile emissions aggregation and trading model of the present invention.

FIG. 2 is a block diagram illustrating the polling and modeling tool aspects of the invention.

FIG. 3 is block diagram illustrating the mobile emissions data collection and calculation tool aspects of the invention.

### DETAILED DESCRIPTION

One embodiment of the inventive method and system includes Internet-based tracking software (“Teletrips”) that allows teleworkers to track their non-trips to the office and their employers to aggregate and trade mobile emissions credits over the Internet. A market system in which emissions reductions from mobile sources can be used to satisfy regulatory requirements for stationary sources is assumed. Reductions in vehicle miles traveled due to telecommuting generate the emissions reductions that are marketable provided air quality plans do not already allocate such reductions to the mobile source sector for transportation conformity purposes.

Through reduced VMT, companies generate potential emissions credits and offer them on an exchange for sale. The price of such credits is established by supply and demand functions typical of the marketplace and outside factors including attainment status, economic situation (e.g. growth), and how an employer implements the telework program.

Participants register over the Internet, by filling out a profile that includes the following information:

The distance between a participant's home and then work place.

The make, year and engine size of a participant's car.

How a participant currently gets to and from work.

Whether a participant parks downtown during a workday.

The time when a participant usually travels to work?

The year and make of vehicle is then compared against the Environmental Protection Agencies Mobil 5 database (or other acceptable databases) to estimate that vehicle's emissions. When a trip is altered or eliminated as a result of an employer allowing an employee to work from home (Telework, Flextime), then a mobile emissions credit is created. These credits are then aggregated and hosted on behalf of the corporate, government and individual customers, in an Application Service Provider (“A.S.P.”) environment.

To trade the aggregated credits, the credits are fed to an emissions exchange. The customer then pays one administration and trading fee as a percentage of the trade. An administration fee is charged for Government and State agencies that use the credits for Environmental compliance.

Teletrips is also designed as a data knowledge tool for polling and modeling. In addition to an ongoing credit tracking and trading tool it will also be used to poll cities to find out how many people do Telework; how many people want to Telework and how many people believe they are able to Telework.

This information is then used in conjunction with a multi-stakeholder modeling software that can model the impact of Telework on:

Environment

Transportation

Energy consumption

Health

Defense

Commerce

This then becomes a consulting service that can be used by Government and Municipalities to evaluate the impact of Telework on a community or city. It can also help the Government query financial or tax incentives on behalf of the stakeholders to determine financial/tax strategies to provide incentives or disincentives for Telework.

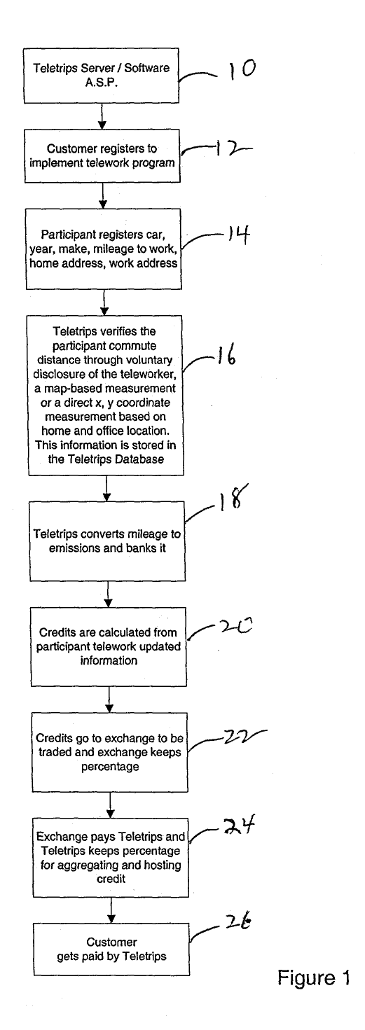

FIG. 1 illustrates an embodiment of the mobile emissions aggregation and trading model. A server 10 implementing the Teletrips system is provided that can be contacted by a customer for purposes of registration 12 via the Internet, or using some other form of remote access. The customer (likely an employer) registers 12 by providing the required data to implement the telework program.

Once the customer has registered 12, teleworkers (likely employees of the customer) can register 14 as participants. Participants are asked to provide specific data such as details regarding their automobile, the location of their workplace, and the location of their home. A participant can specify the distance between their workplace and their home. This data will be verified 16 by the Teletrips System using one of three methods: calculations derived from the voluntary disclosure of the teleworker; a map based measurement; or an x,y coordinate measurement based on a teleworker's provided home and office location.

After establishing the distance between a teleworker's home and workplace the Teletrips System converts 18 the distance (mileage) to emissions. Credits are calculated and are updated 20 from data provided by the participant regarding teleworking. All credits generated can be traded 22 on the exchange limited only by a percentage the exchange keeps for itself.

Periodically or immediately following a trade of credits the exchange will pay 24 the operator of the Teletrips System. The operator takes a percentage of this payment as remuneration for aggregating and hosting activities. The remainder of the credit is paid 26 to the customer by the operator.

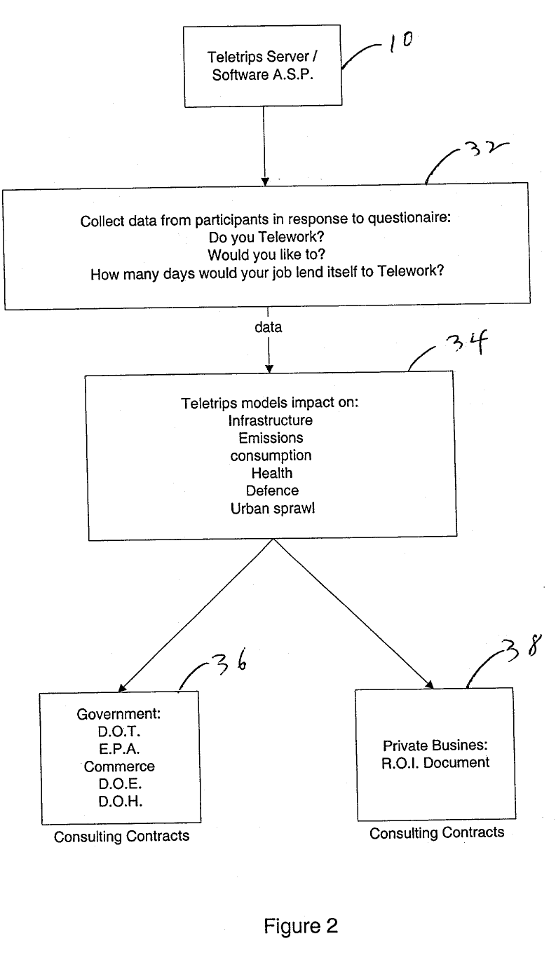

FIG. 2 depicts the periodic collection of data initiated by the Teletrips System 10 to gather 32 updated data from all the participants regarding their most recent telework activities. This data can be manipulated and applied in a variety of modes 34, for example through models to derive the impact of telework on infrastructure, emissions, consumption, health, defence and urban sprawl. The data can then be distributed 38, 36 in electronic or hard format to a variety of public sector and private sector organizations to fulfill consulting contracts that the operator of the Teletrips System has executed with such organizations.

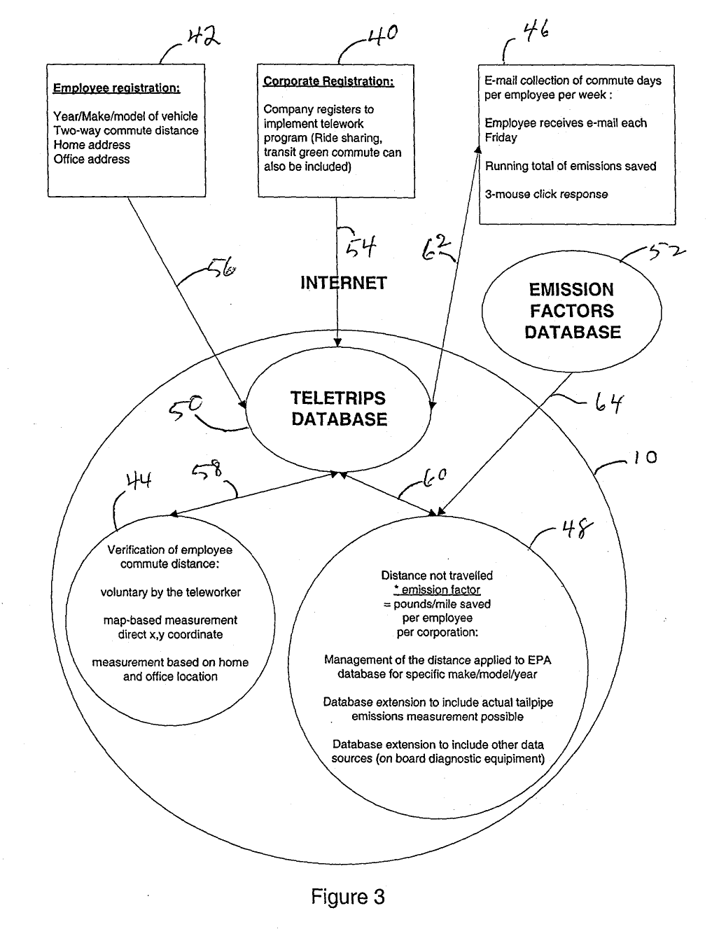

FIG. 3 is an illustration of the transfer of data gathered externally and calculated internally by the Teletrips System 10 and the storage of data in a Teletrips database 50. A customer (likely a corporate organization) causes data to be transferred by providing 40 requested information during a remote access registration process. Customer registration data is transferred for storage 54 to the Teletrips database 50.

Via a communications network, such as the Internet, a participant (likely an employee of the customer) transfers 56 requested data to the Teletrips Database 50 through a remote access registration process 42. Following the registration of a participant 42, details related to a teleworker's commute are extracted 58 from the Teletrips Database 50 and a participant's commute distance is verified 44. The verified data is transferred 58 for storage in the Teletrips Database.

Periodically (e.g., weekly), update requests are sent 62 via the Teletrips System 10 to participants via a remote access method for the purpose of collecting data 46 regarding recent telework activity from each participant. Data collected from a participant is transferred 62 for storage in the Teletrips Database 50.

The Teletrips System 10 extracts data 60 from the Teletrips Database 50 to complete the following calculation 48:

distance not traveled*emission factor=pounds/mile saved per employee per employer

To determine the emissions factor an external server, such as an emission factors database 52, is accessed and the corresponding emissions factor is extracted 64 for use in the calculation. Calculation data is transferred 60 for storage in the Teletrips Database 50.

The present embodiment described above is to be considered as illustrative and not restrictive, and the invention is not to be limited to the details given herein, but may be modified within the scope and equivalents of the appended claims.

What is claimed is:

1. A method of tracking pollution credits earned by an employer through the application of a telework program comprising:
registering an employee of the employer;
receiving communications from the employee of data respecting telework performed by the employee;
calculating pollution credits earned by the employer as a result of the telework performed by the employee; and
communicating the pollution credits earned by the employer to a third party server.

2. The method of claim 1, wherein communications from the employee of data respecting telework performed by the employee are received via a communications network in response to reminders sent by via the communications network to the employee.

3. The method of claim 2, additionally comprising storing in a database data respecting telework performed by the employee.

4. The method of claim 3, wherein registering the employee includes collecting data regarding the distance between the employee's home and the usual workplace provided by the employer for use by the employee.

5. The method of claim 4, additionally comprising calculating the distance between the employee's home the usual workplace provided by the employer the employee utilizing the data provided by the employee.

6. A system for tracking pollution credits earned by an employer through the application of a telework program comprising:
means for registering an employee of the employer;
means for receiving communications from the employee of data respecting telework performed by the employee;
means for calculating pollution credits earned by the employer as a result of the telework performed by the employee; and
means for communicating the pollution credits earned by the employer to a third party server.

7. The system of claim 6, wherein communications from the employee of data respecting telework performed by the employee are received via a communications network in response to reminders sent by via the communications network to the employee.

8. The system of claim 7, additionally comprising a database for storing data respecting telework performed by the employee.

9. The system of claim 8, wherein the registration means includes means for collecting data from the employee regarding the distance between the employee's home and the usual workplace provided by the employer for use by the employee and storing the data in the database.

10. The system of claim 9, additionally calculation means includes means for calculating the distance between the employee's home the usual workplace provided by the employer the employee utilizing the data provided by the employee.
